(19) United States
(12) Patent Application Publication
(10) Pub. No.: US 2026/0276880 A1
(43) Pub. Date: Sep. 17, 2026

(54) BACKLIGHT MODULE AND DISPLAY DEVICE

(71) Applicant: Guangzhou China Star Optoelectronics Semiconductor Display Technology Co., LTd., Guangzhou (CN)

(72) Inventor: Kun WANG, Guangzhou (CN)

(73) Assignee: Guangzhou China Star Optoelectronics Semiconductor Display Technology Co., LTd., Guangzhou (CN)

(21) Appl. No.: 19/285,666

(22) Filed: Jul. 30, 2025

(30) Foreign Application Priority Data
Mar. 17, 2025 (CN) 202510314833.3

(51) Int. Cl. F21V 8/00

(52) U.S. Cl. CPC G02B 6/009; G02B 6/0073

(57) ABSTRACT

The present disclosure provides a backlight module and a display device. The backlight module includes a light guide plate, a light source assembly, and a driving circuit. The light guide plate includes a light-emitting surface, a bottom surface opposite to the light-emitting surface, and a lateral surface connecting the light-emitting surface and the bottom surface. A mounting groove is provided on the lateral surface. The light source assembly is arranged in the mounting groove. The driving circuit is electrically connected to the light source assembly. The driving circuit is arranged on at least one of the light-emitting surface and the bottom surface, and the driving circuit is located adjacent to the light source assembly.

### CROSS-REFERENCE TO RELATED APPLICATION

This application claims priority to Chinese Patent Application No. 202510314833.3, filed on Mar. 17, 2025. The disclosure of the aforementioned application is incorporated herein by reference in its entirety.

### TECHNICAL FIELD

The present disclosure relates to the field of display technologies, in particular to a backlight module and a display device.

### BACKGROUND

When a liquid crystal display device operates normally, a light source needs to be provided to provide necessary light for the liquid crystal display device. Commonly used backlight modules are classified into direct-lit backlight modules and edge-lit backlight modules. Since the light source of the direct-lit backlight module is located below a display panel, the light source additionally increases an overall thickness of the display device. In order to meet the demand of thinning the liquid crystal display devices, edge-lit backlight modules have been more widely used.

### SUMMARY

Embodiments of the present disclosure provide a backlight module, including: a light guide plate including a light-emitting surface, a bottom surface opposite to the light-emitting surface, and a lateral surface connecting the light-emitting surface and the bottom surface, a mounting groove being provided on the lateral surface; a light source assembly arranged in the mounting groove; and a driving circuit electrically connected to the light source assembly. The driving circuit is arranged on at least one of the light-emitting surface and the bottom surface, and the driving circuit is located adjacent to the light source assembly.

Embodiments of the present disclosure also provide a display device, including a display panel and the backlight module as described in any of the above embodiments. The backlight module includes the light guide plate and an optical film layer arranged in a stacked manner, the optical film layer is arranged between the light guide plate and the display panel, a side of the optical film layer is attached to the light guide plate, and another side of the optical film layer is attached to the display panel.

### BRIEF DESCRIPTION OF THE DRAWINGS

In order to more clearly describe the technical proposals in the embodiments or related arts, the drawings that need to be used in the description of the embodiments or the related arts will be briefly introduced below. It will be apparent that the accompanying drawings in the description are merely exemplary of the disclosure, and other drawings can be obtained from these drawings without making creative efforts to those skilled in the art.

FIG. 1 is a first structural schematic diagram of a backlight module provided by embodiments of the present disclosure.

FIG. 2 is a schematic cross-sectional view of A-A′ in FIG. 1 provided by embodiments of the present disclosure.

FIG. 3 is a local front-view structural schematic diagram along a B direction in FIG. 1 provided by embodiments of the present disclosure.

FIG. 4 is an enlarged schematic diagram at C in FIG. 2 provided by embodiments of the present disclosure.

FIG. 5 is a local front-view structural schematic diagram along a D direction in FIG. 1 provided by embodiments of the present disclosure.

FIG. 6 is a schematic cross-sectional view of E-E′ in FIG. 1 provided by embodiments of the present disclosure.

FIG. 7 is an enlarged schematic diagram at F in FIG. 3 provided by embodiments of the present disclosure.

FIG. 8 is a local front-view structural schematic diagram along a G direction in FIG. 1 provided by embodiments of the present disclosure.

FIG. 9 is a second structural schematic diagram of a backlight module provided by embodiments of the present disclosure.

FIG. 10 is an enlarged schematic diagram at H in FIG. 9 provided by embodiments of the present disclosure.

FIG. 11 is a local front-view structural schematic diagram in an I direction in FIG. 9 provided by embodiments of the present disclosure.

FIG. 12 is a schematic structural diagram of a display device provided by embodiments of the present disclosure.

### REFERENCE NUMERALS

1, backlight module; 11, light source assembly; 12, light guide plate; 13, driving circuit; 14, optical film layer; 15, reflective layer; 16, dot; 17, conductive member; 18, light-shielding adhesive; 19, connecting member; 111, pin; 1111, first pin; 1112, second pin; 112, light source; 121, light-emitting surface; 1211, wire slot; 122, bottom surface; 123, lateral surface; 1231, mounting groove; 12311, light-receiving surface; 12312, mounting sub-groove; 124, connecting groove; 1241, first sub-groove; 1242, second sub-groove; 1243, limiting groove; 131, first conductive wire; 132, second conductive wire; 1321, first conductive sub-wire; 133, third conductive wire; 2, display device; 21, display panel; 22, housing.

### DETAILED DESCRIPTION

Technical proposals in embodiments of the present disclosure will be described clearly and completely below in conjunction with the accompanying drawings in the embodiments of the present disclosure, and it is apparent that described embodiments are only some of the embodiments and not all of the embodiments of the present disclosure. Based on the embodiments of the present disclosure, all other embodiments obtained by those skilled in the art without creative work fall within the protection scope of the present disclosure. In addition, it should be understood that specific embodiments described herein are only used to explain and illustrate the present disclosure and are not intended to limit the present disclosure. In the present disclosure, unless specified to the contrary, the orientational terms “upper” and “lower” usually refer to the actual use or working condition of the device, especially the orientations shown in the accompanying drawings, while the terms “inside” and “outside” are referred to with respect to a profile of the device.

Therefore, the features limited to “first” and “second” may explicitly or implicitly include one or more features. In the description of the present disclosure, “plurality of” means two or more, unless expressly and specifically defined otherwise.

In the description of the present disclosure, it is to be noted that, unless expressly stated and defined otherwise, the terms “install”, “communicate”, and “connect” are to be understood in a broad sense, for example, as a fixed connection, as a detachable connection, as an mechanical connection, as an electrical connection, as an communication with each other, as an direct connection, as an indirect connection by means of an intermediate medium, as an internal communication of two elements, or as an interaction of two elements. The specific meaning of the above terms in the present disclosure may be understood by one of ordinary skill in the art depending on the specific circumstances.

The following provides many different embodiments for implementing the different structures of the present disclosure. To simplify the disclosure of the present disclosure, the components and arrangements of specific examples are described below. It should be understood, they are merely examples and are not intended to limit the present disclosure. In addition, the present disclosure provides examples of various specific processes and materials, but those skilled in the art can realize the application of other processes and/or the use of other materials.

The edge-lit backlight module in related arts includes a reflective sheet, a light source, a light guide plate, a backplate, and a frame adhesive. The light source is arranged on a lateral side of the light guide plate. Due to the certain volume limitations of the backplate and frame adhesive, the thickness of the edge-lit backlight module is relatively large, which is difficult to meet the requirements for thickness of display devices with high thickness requirements. This limits its wide application in thin display devices.

Embodiments of the present disclosure provide a backlight module and a display device, which are configured for reducing production costs and improving assembly efficiency of the backlight module.

To realize the above functions, the technical proposals provided in the embodiments of the present disclosure are as follows:

Embodiments of the present disclosure provide a backlight module, including: a light guide plate including a light-emitting surface, a bottom surface opposite to the light-emitting surface, and a lateral surface connecting the light-emitting surface and the bottom surface, a mounting groove being provided on the lateral surface; a light source assembly arranged in the mounting groove; and a driving circuit electrically connected to the light source assembly. The driving circuit is arranged on at least one of the light-emitting surface and the bottom surface, and the driving circuit is located adjacent to the light source assembly.

In some embodiments, the light guide plate is provided with a connecting groove, and the connecting groove is communicated with the mounting groove; and pins of the light source assembly are connected in the connecting groove in a slidable manner, and the pins of the light source assembly are electrically connected to the driving circuit through the connecting groove.

In some embodiments, the connecting groove includes: a first sub-groove provided on the light-emitting surface, wherein the first sub-groove penetrates part of the light guide plate along a thickness direction of the backlight module; and a second sub-groove provided on the lateral surface, wherein the second sub-groove penetrates part of the light guide plate along a length direction of the backlight module, and the second sub-groove is communicated with the mounting groove. The driving circuit covers an opening of the first sub-groove, the backlight module includes a conductive member arranged in the first sub-groove, an end of the conductive member is electrically connected to the driving circuit, and another end of the conductive member is electrically connected to the pins of the light source assembly.

In some embodiments, the connecting groove further includes a limiting groove, the limiting groove is provided on a side of the first sub-groove away from the driving circuit, and the limiting groove is communicated with the first sub-groove; and the pins of the light source assembly are arranged in the limiting groove, and the pins of the light source assembly are snap-fitted with the limiting groove.

In some embodiments, the limiting groove is communicated with the second sub-groove, a distance between a bottom of the limiting groove and the light-emitting surface is greater than a distance between a side of the second sub-groove away from the light-emitting surface and the light-emitting surface, such that a stepped limiting structure is formed.

In some embodiments, the conductive member is arranged on a side of the pins of the light source assembly away from the limiting groove, and at least part of the conductive member is located in the limiting groove.

In some embodiments, the mounting groove includes a plurality of mounting sub-grooves arranged at intervals along a width direction of the backlight module, the light source assembly includes a plurality of light sources arranged at intervals along the width direction of the backlight module, each of the light sources is arranged in a corresponding one of the mounting sub-grooves, and each of the light sources includes a first pin and a second pin; and the driving circuit includes a first conductive wire and a second conductive wire, one of the first conductive wire and the second conductive wire is electrically connected to the first pin, and another one of the first conductive wire and the second conductive wire is electrically connected to the second pin.

In some embodiments, the first conductive wire extends along the width direction of the backlight module, and the first conductive wire is electrically connected to the first pin of each of the plurality of light sources; and the second conductive wire includes a plurality of first conductive sub-wires arranged at intervals along a length direction of the backlight module, each of the first conductive sub-wires extends along the width direction of the backlight module, each of the first conductive sub-wires is electrically connected to the second pin of a corresponding one of the light sources.

In some embodiments, lengths of the plurality of first conductive sub-wires are different along the width direction of the backlight module.

In some embodiments, the mounting groove includes a plurality of mounting sub-grooves arranged at intervals along a width direction of the backlight module, the light source assembly includes a plurality of light sources arranged at intervals along the width direction of the backlight module, each of the light sources is arranged in a corresponding one of the mounting sub-grooves, and each of the light sources includes a first pin and a second pin; and the driving circuit includes a first conductive wire, a second conductive wire, and a plurality of third conductive wires. The first conductive wire is electrically connected to the first pin of one of the light sources located at an end of the backlight module, and the second conductive wire is electrically connected to the second pin of another one of the light sources located at another end of the backlight module, each of the third conductive wires is arranged between two adjacent ones of the light sources, one end of each of the third conductive wires is connected to the first pin of one of the light sources and another end of each of the third conductive wires is connected to the second pin of another one of the light sources.

In some embodiments, the backlight module further includes a reflective layer, the reflective layer is disposed on the bottom surface of the light guide plate, and the reflective layer is in direct contact with a housing.

In some embodiments, a plurality of wire slots are provided on the light-emitting surface of the light guide plate, and the driving circuit is embedded in the wire slots.

In some embodiments, the backlight module further includes an optical film layer, and the optical film layer is arranged on the light-emitting surface of the light guide plate and is spaced apart from the driving circuit.

In some embodiments, the light guide plate includes a light-receiving surface located on a side of the mounting groove away from the light source assembly, and a distance between the light-receiving surface and the light source assembly is greater than or equal to zero.

In some embodiments, a cross section of the light-receiving surface is arc-shaped and convex in a direction away from the light source assembly.

In some embodiments, the backlight module further includes a plurality of dots arranged inside the light guide plate, and the plurality of dots are arranged on at least one of a side of the bottom surface adjacent to the light-emitting surface and a side of the light-receiving surface away from the light source assembly.

In some embodiments, the backlight module further includes a connecting member, an end of the connecting member is arranged on the light-emitting surface of the light guide plate and is electrically connected to the driving circuit, and another end of the connecting member is bent along a lateral side of the light guide plate to a side of the bottom surface away from the light-emitting surface and is connected to an external driving circuit or control circuit.

Embodiments of the present disclosure also provide a display device, including a display panel and the backlight module as described in any of the above embodiments. The backlight module includes the light guide plate and an optical film layer arranged in a stacked manner, the optical film layer is arranged between the light guide plate and the display panel, a side of the optical film layer is attached to the light guide plate, and another side of the optical film layer is attached to the display panel.

In some embodiments, the optical film layer is arranged on the light-emitting surface of the light guide plate and is spaced apart from the driving circuit.

In some embodiments, the backlight module further includes a light-shielding adhesive arranged between the light guide plate and the display panel, and the light guide plate and the display panel are attached and fixed by the light-shielding adhesive.

In the backlight module and the display device provided by the embodiments of the present disclosure, by integrating the light source assembly, the driving circuit, and the light guide plate, a backplate structure in the related backlight module is omitted, thereby reducing the number of components of the backlight module, lowering production costs, and achieving the thinning.

Specific embodiments of the present disclosure will be described in detail below with reference to the accompanying drawings.

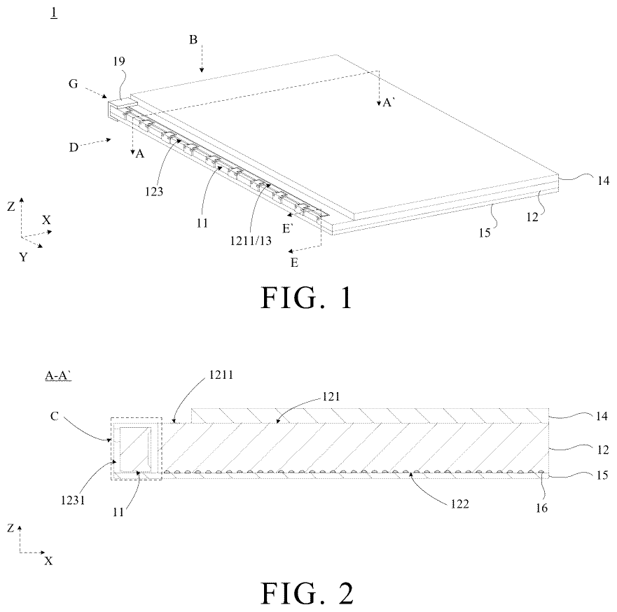

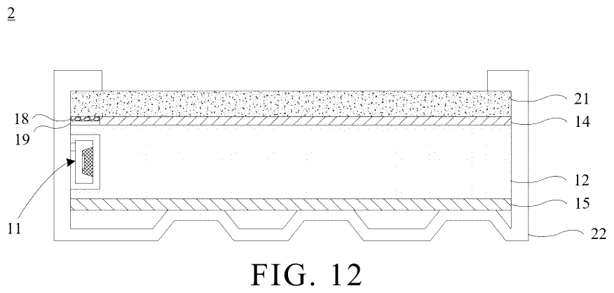

Please combine FIG. 1, FIG. 2, and FIG. 12, embodiments provide a backlight module 1. The backlight module 1 includes a light source assembly 11, a light guide plate 12, a driving circuit 13, an optical film layer 14, and a reflective layer 15. The light guide plate 12 includes a light-emitting surface 121, a bottom surface 122 opposite to the light-emitting surface 121, and a lateral surface 123 connecting the light-emitting surface 121 and the bottom surface 122. A mounting groove 1231 is provided on the lateral surface 123, and the light source assembly 11 is disposed in the mounting groove 1231, so that the light source assembly 11 is located inside the light guide plate 12, and the light emitted by the light source assembly 11 can be completely incident into the light guide plate 12, thereby improving the light utilization rate of the light source assembly 11, and improving the luminous brightness of the backlight module 1.

A material of the light guide plate 12 includes, but is not limited to, glass. It can be understood that in the related arts, the material of the light guide plate is usually a material with low rigidity such as polymethyl methacrylate (PMMA) or styrene-methyl methacrylate copolymer (MC), so it is necessary to provide a metal backplate to support the entire backlight module, which increases the material consumption of the backlight module, and at the same time increases the thickness of the backlight module, failing to meet the demand of thinning. In the embodiments, by setting the material of the light guide plate 12 as glass, utilizing the physical characteristics of high rigidity of glass, the light guide plate 12 replaces the metal backplate, allowing the light guide plate 12, the optical film layer 14, and the display panel 21 to be directly attached. The light guide plate 12 serves as a carrier of the backlight module 1, thereby saving the material consumption, reducing the costs of the backlight module 1, and meeting the demand of thinning the backlight module 1.

The driving circuit 13 is arranged on the light-emitting surface 121 and/or the bottom surface 122, and the driving circuit 13 is located adjacent to the light source assembly 11. The driving circuit 13 is electrically connected to the light source assembly 11, and a driving current is provided to the light source assembly 11 through the driving circuit 13, so that the light source assembly 11 emits light normally. It can be understood that in the embodiments, by integrating the light source assembly 11, the driving circuit 13, and the light guide plate 12, a backplate structure in the related backlight module 1 is omitted, thereby reducing the number of components of the backlight module 1, reducing the production costs, and realizing thinning.

Specifically, in the embodiments, that the driving circuit 13 is provided on the light-emitting surface 121 is taken as an example. It is intended to facilitate the description of the connection mode and layout between the driving circuit 13 and the light source assembly 11. Specifically, a plurality of wire slots 1211 are provided on the light-emitting surface 121 of the light guide plate 12, and the driving circuit 13 is disposed in the wire slots 1211, thereby improving the stability and reliability of the driving circuit 13. The driving circuit 13 is embedded in the wire slots 1211, which helps to reduce an overall thickness of the backlight module 1, optimize space utilization, and ensure that the optical performance of the light guide plate 12 is not affected.

It should be noted that in other embodiments, a position of the driving circuit 13 may be adjusted according to actual needs, for example, the driving circuit 13 may be provided on the lateral surface or the bottom surface of the light guide plate 12, and should not be limited to the specific structure in the embodiments. Through this flexible design method, it is possible to adapt to different structures and application requirements of the display device 2, and at the same time, it is ensured that the driving circuit 13 can be effectively electrically connected to the light source assembly 11, thereby ensuring normal operation and stability of the light source assembly 11.

Furthermore, the optical film layer 14 is arranged on the light-emitting surface 121 of the light guide plate 12. The optical film layer 14 includes multiple layers of optical film sheets, and the optical film sheets include, but are not limited to, one of a diffuser sheet, a prism sheet, and a brightness enhancement sheet, which is not specifically limited in the embodiment. The optical film layer 14 is spaced apart from the driving circuit 13, thereby preventing the driving circuit 13 from affecting the attaching quality and optical performance of the optical film layer 14, ensuring normal operation of the optical film sheets, and improving light uniformity and brightness effects. At the same time, the interference of the driving circuit 13 on the optical film layer 14 is reduced, and the overall display effect and reliability of the backlight module 1 are improved.

The reflective layer 15 is arranged on the bottom surface 122 of the light guide plate 12, and the reflective layer 15 is in a direct contact with a housing. The reflective layer 15 covers the bottom surface 122 of the light guide plate 12, thereby preventing the light emitted by the light source assembly 11 from being emitted from the bottom of the light guide plate 12, that is, the reflective layer 15 reflects the light leaked from the bottom surface 122 of the light guide plate 12, and transmits the light into the light guide plate 12, thereby improving the light emission efficiency of the backlight module 1.

It should be noted that the aforementioned housing refers to a housing structure of the display device 2 that assembles the backlight module. The housing of the display device 2 is usually an external protective structure, primarily configured to protect the display panel 21 and the backlight module inside the housing. The housing provides protection from external environments and offers mechanical support for internal components.

Specifically, the reflective layer 15 may have a single-layer film structure or a composite structure in which multiple layers of films are sequentially stacked. Under the condition that the reflective layer 15 is a composite structure in which multiple layers of films are sequentially stacked, the reflective layer 15 includes, but is not limited to, a protective film, a buffer film, and a reflective film that are stacked. It can be understood that when the reflective layer 15 is in a direct contact with the housing by adopting the composite structure with multiple layers, the buffer layer can absorb mechanical vibration energy, and the protective film can prevent collisions between hard materials and the reflective layer 15, which could cause wear to the reflective layer 15, thereby ensuring the reliability of the reflective layer 15. It is to be understood that the structure of the reflective layer 15 is not specifically limited in the embodiments.

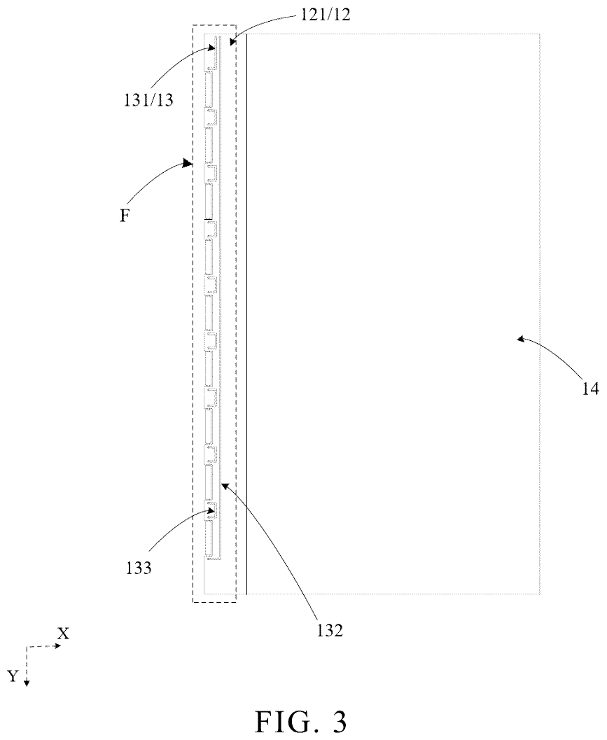

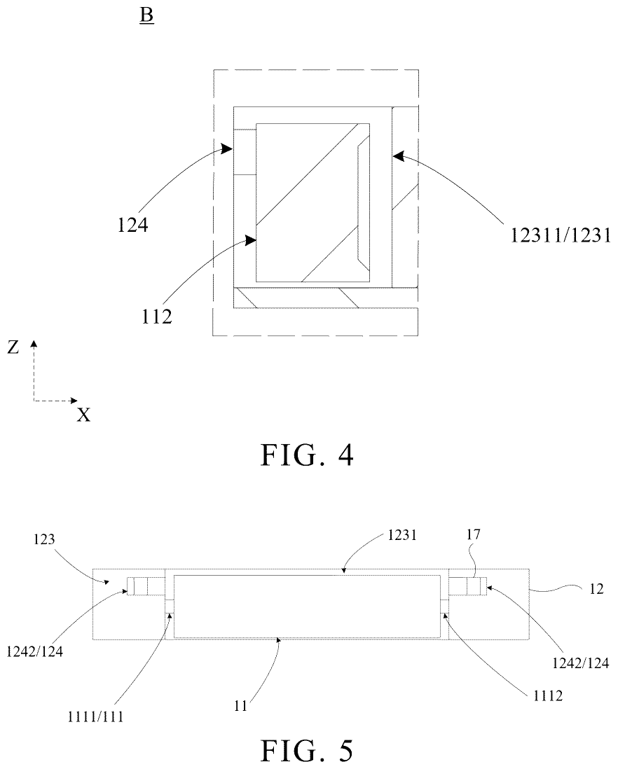

Please combine FIG. 1, FIG. 2, FIG. 3, and FIG. 4, in some embodiment, a shape of the mounting groove 1231 may match the size of the light source assembly 11, and the light source assembly 11 is fixedly connected in the mounting groove 1231, thereby reducing the risk of relative displacement between the light source assembly 11 and the light guide plate 12 under vibration or external force impact of the backlight module 1, and improving the reliability of the backlight module 1.

Furthermore, the light guide plate 12 includes a light-receiving surface 12311. The light-receiving surface 12311 is located on a side of the mounting groove 1231 away from the light source assembly 11, and a distance between the light-receiving surface 12311 and the light source assembly 11 is greater than or equal to 0. Specifically, the light-receiving surface 12311 is spaced apart from the light source assembly 11, and a cross section of the light-receiving surface 12311 is one of a triangle, a rectangle, or an arc shape. The embodiments are illustrated by taking that the cross section of the light-receiving surface 12311 is a rectangle, and the light-receiving surface 12311 is convex in a direction away from the light source assembly 11 as an example. It should be noted that, in other embodiments, the cross section of the light-receiving surface 12311 may be adjusted according to actual needs, for example, the cross section of the light-receiving surface 12311 is arc-shaped.

It can be understood that in the embodiments, by designing the cross section of the light-receiving surface 12311 to be arc-shaped, and designing the light-receiving surface 12311 to be convex in a direction away from the light source assembly 11, an range of an incident angle of the light emitted by the light source assembly 11 is expanded, allowing more light to enter the light guide plate 12 at angles close to the critical angle of total internal reflection, thereby reducing light energy loss.

It should be noted that the aforementioned light-receiving surface 12311 and the light source assembly 11 being spaced apart is provided merely as an example. In some other embodiments, the distance between the light-receiving surface 12311 and the light source assembly 11 is zero, that is, the light-receiving surface 12311 is in direct contact with the light source assembly 11. This forms a zero-gap fit between the light source assembly 11 and the light-receiving surface 12311 of the light guide plate 12, thereby reducing light leakage loss from the lateral surface 123 of the light source assembly 11 and further improving the light utilization efficiency of the light source assembly 11.

Please continue to combine FIG. 1, FIG. 2, FIG. 3, and FIG. 4, in some embodiments, the backlight module 1 further includes a plurality of dots 16. The plurality of dots 16 are arranged on a side of the bottom surface 122 adjacent to the light-emitting surface 121, and/or the plurality of dots 16 are arranged on a side of the light-receiving surface 12311 away from the light source assembly 11. The plurality of dots 16 are arranged inside the light guide plate 12.

It can be understood that the light emitted by the light source assembly 11 enters the light guide plate 12 through the light-receiving surface 12311. When the light encounters the dots 16 arranged inside the light guide plate 12, it scatters. A part of the light scattered by the dots 16 exits through the light-emitting surface 121 of the light guide plate 12, and another part of the light scattered by the dots 16 continues to be transmitted inside the light guide plate 12 until it encounters the dots 16 again, scatters once more, and then exits through the light-emitting surface 121 of the light guide plate 12. This effectively alleviates the issue of light energy loss.

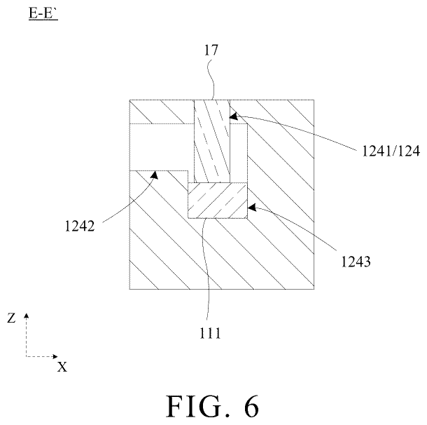

Please combine FIG. 1, FIG. 2, FIG. 3, FIG. 4, FIG. 5, and FIG. 6, in some embodiments, the light guide plate 12 is provided with a connecting groove 124, and the connecting groove 124 is communicated with the mounting groove 1231. Pins 111 of the light source assembly 11 are connected in the connecting groove 124 in a slidable manner, and the pins 111 of the light source assembly 11 are electrically connected to the driving circuit 13 through the connecting groove 124, thereby achieving accurate positioning of the light source assembly 11 through the cooperative effect of the connecting groove 124 and the mounting groove 1231. At the same time, the connecting groove 124 can isolate moisture and particle pollution, and improve the stability of the electrical connection between the pins 111 of the light source assembly 11 and the driving circuit 13.

Specifically, when the light source assembly 11 is installed, the light source assembly 11 is located in the mounting groove 1231, and the pins 111 of the light source assembly 11 are connected in the connecting groove 124 in a slidable manner, so that the pins 111 of the light source assembly 11 can be inserted and fixed in the connecting groove 124, thereby realizing the electrical connection between the light source assembly 11 and the driving circuit 13 without additional welding or complicated assembly steps, improving the assembly efficiency of the backlight module 1, and reducing the production costs. At the same time, by directly sliding the pins of the light source assembly 11 into the light guide plate 12, the light source assembly 11 is integrated on the light guide plate 12, thereby reducing the thickness of the backlight module 1 and realizing the thinning design of the backlight module 1.

Furthermore, the mounting groove 1231 penetrates the light guide plate 12 along a thickness direction of the backlight module 1, thereby aiding in optimizing an arrangement of the light source assembly 11, so that the light source assembly 11 can be positioned closer to the lateral surface 123 or the inside of the light guide plate 12, thereby improving light coupling efficiency, reducing light loss, and enhancing brightness uniformity of the backlight module 1. At the same time, the mounting groove 1231 penetrates the light guide plate 12 along the thickness direction of the backlight module 1, which can facilitate the installation and replacement of the light source assembly 11, and improve the maintainability and assembly efficiency of the backlight module 1.

The connecting groove 124 includes a first sub-groove 1241 and a second sub-groove 1242 communicated with each other. The first sub-groove 1241 is provided on the light-emitting surface 121, the first sub-groove 1241 penetrates a part of the light guide plate 12 along the thickness direction of the backlight module 1, and the driving circuit 13 covers an opening of the first sub-groove 1241. The second sub-groove 1242 is provided on the lateral surface 123, the second sub-groove 1242 penetrates a part of the light guide plate 12 along a length direction of the backlight module 1, and the second sub-groove 1242 and the mounting groove 1231 are communicated with each other. The backlight module 1 includes a conductive member 17 arranged in the first sub-groove 1241. An end of the conductive member 17 is electrically connected to the driving circuit 13, and another end of the conductive member 17 is electrically connected to the pins 111 of the light source assembly 11, thereby realizing the electrical connection between the light source assembly 11 and the driving circuit 13.

It should be noted that, in order to clarify the definition of spatial orientation and more clearly describe the relative position and structural arrangement of each component, the embodiments take the thickness direction of the backlight module as the Z direction in the drawings of the specification, the length direction of the backlight module as the X direction in the drawings of the specification, and the width direction of the backlight module as the Y direction in the drawings of the specification as an example for illustration.

It can be understood that in the embodiments, by disposing the conductive member 17 in the first sub-groove 1241, the light source assembly 11 can be electrically connected to the driving circuit 13 through the conductive member 17, thereby reducing the use of an external circuit board and further reducing the overall thickness of the backlight module 1. At the same time, the conductive member 17 is embedded in the first sub-groove 1241, so that a structure of the light guide plate 12 is more compact and stable, thereby reducing the risk of shaking or falling off of the light source assembly 11, and improving the prolonged use reliability of the backlight module 1.

Specifically, the first sub-groove 1241 is located on a side of the driving circuit 13 adjacent to the light source assembly 11, the first sub-groove 1241 penetrates a part of the light guide plate 12 along the thickness direction of the backlight module 1, and the opening of the first sub-groove 1241 is located on the light-receiving surface 12311. By providing the driving circuit 13 to cover the opening of the first sub-groove 1241, the electrical connection between the driving circuit 13 and the conductive member 17 located in the first sub-groove 1241 is realized. An opening of the second sub-groove 1242 is located on the lateral surface 123, the second sub-groove 1242 penetrates a part of the light guide plate 12 along the length direction of the backlight module 1, and the second sub-groove 1242 is communicated with the mounting groove 1231, so that the pins 111 of the light source assembly 11 can be smoothly inserted into the second sub-groove 1242.

The pins 111 of the light source assembly 11 can be connected in the second sub-groove 1242 in a slidable manner, and the conductive member 17 is located in the first sub-groove 1241, so that the pins 111 of the light source assembly 11 can slid in the second sub-groove 1242 to a position where the conductive member 17 is located to achieve the electrical connection between the pins 111 of the light source assembly 11 and the driving circuit 13. An end of the conductive part 17 is electrically connected to the driving circuit 13, and another end of the conductive member 17 is electrically connected to the pins 111 of the light source assembly 11, thereby realizing the electrical connection between the light source component 11 and the driving circuit 13.

Furthermore, the connecting groove 124 further includes a limiting groove 1243. The limiting groove 1243 is provided on a side of the first sub-groove 1241 away from the driving circuit 13, and the limiting groove 1243 is communicated with the first sub-groove 1241. The pins 111 of the light source assembly 11 is arranged in the limiting groove 1243, and the pins 111 of the light source assembly 11 are snap-fitted with the limiting groove 1243, so that the light source assembly 11 can be securely embedded in the connecting groove 124 during assembly. The limiting groove 1243 can limit a position of the light source assembly 11, improve assembly consistency, and avoid the problem such as poor electrical connection caused by component displacement.

It can be understood that the pins 111 of the light source assembly 11 are arranged in the limiting groove 1243 and are fixed in the limiting groove 1243 by a snap-fit connection, so that the light source assembly 11 can be automatically aligned and fixedly connected to the light guide plate 12 during assembly without additional welding or support structure, thereby improving the assembly efficiency of the light source assembly 11 and reducing the manufacturing costs.

At the same time, the pins 111 of the light source assembly 11 are configured to abut against an inner wall of the limiting groove 1243. After the pins 111 of the light source assembly 11 slide into the limiting groove 1243, a self-locking effect is formed, and the limiting groove 1243 can limit the displacement of the light source assembly 11 in the length direction and the width direction of the backlight module 1, thereby reduce the risk of relative displacement between the light source assembly 11 and the light guide plate 12 under vibration or external force impact, and improving the reliability of the backlight module 1.

Specifically, the limiting groove 1243 is communicated with the second sub-groove 1242. A distance between a bottom of the limiting groove 1243 and the light-emitting surface 121 is greater than a distance between a side of the second sub-groove 1242 away from the light-emitting surface 121 and the light-emitting surface 121, so that a stepped limiting structure is formed, allowing the pins 111 of the light source assembly 11 to smoothly slide into the limiting groove 1243 during installation, and enabling a stable snap-fit connection between the pins 111 of the light source assembly 11 and the limiting groove 1243. This prevents poor electrical connections caused by misalignment or assembly errors of the pins 111 of the light source assembly 11. At the same time, it ensures that the light source assembly 11 does not loosen or displaced due to factors such as vibration or thermal expansion during prolonged use, thereby improving the assembly precision and stability of the backlight module 1.

Furthermore, the conductive member 17 is arranged on a side of the pins 111 of the light source assembly 11 away from the limiting groove 1243, and at least part of the conductive member 17 is located in the limiting groove 1243, thereby enhancing the stability of the light source assembly 11 and preventing the pins 111 of the light source assembly 11 from being loosened or displaced due to vibration or external force during use. At the same time, the reliability of electrical connection between the light source assembly 11 and the driving circuit 13 can be improved, stable signal transmission can be ensured, and the problem such as uneven light emission or flickering caused by poor contact can be reduced.

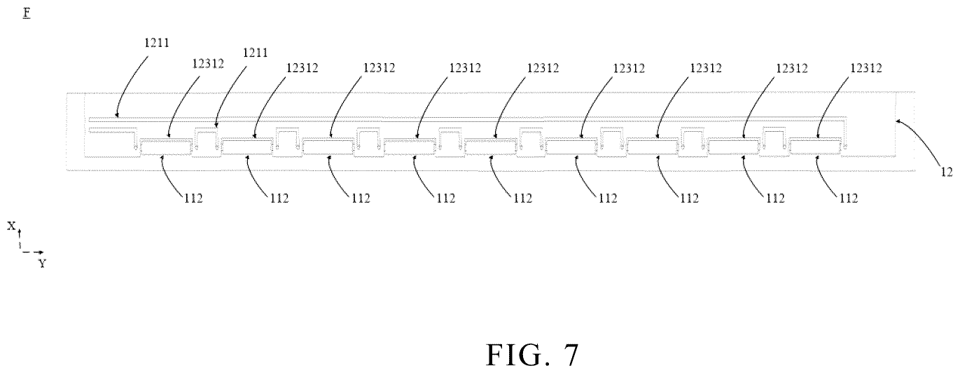

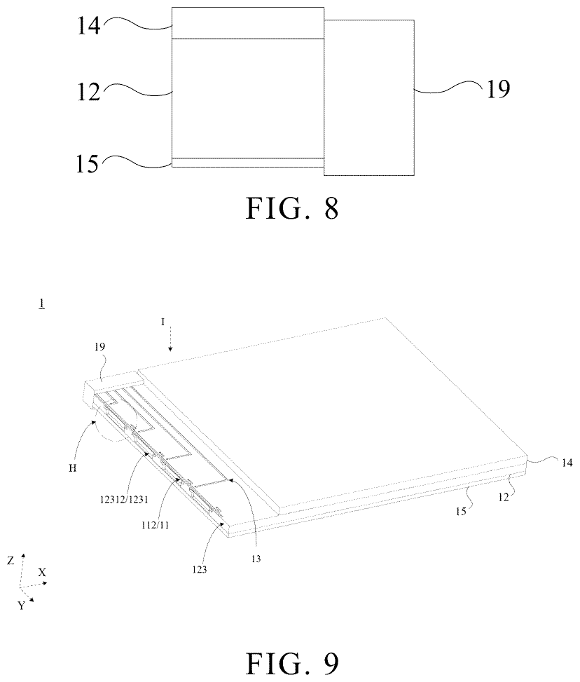

Please combine FIG. 1, FIG. 2, FIG. 3, FIG. 4, FIG. 5, FIG. 6, FIG. 7, and FIG. 8, in some embodiments, the mounting groove 1231 includes a plurality of mounting sub-grooves 12312 arranged at intervals along the width direction of the backlight module 1, the light source assembly 11 includes a plurality of light sources 112 arranged at intervals along the width direction of the backlight module 1, and each of the light sources 112 is arranged in a corresponding one of the mounting sub-grooves 12312, so that the light source assembly 11 is evenly distributed in the light guide plate 12, and the uniformity and stability of the plurality of light sources 112 are improved.

Each of the light sources 112 includes a first pin 1111 and a second pin 1112, and any two adjacent light sources 112 are connected in series. The driving circuit 13 includes a first conductive wire 131, a second conductive wire 132, and a plurality of third conductive wires 133, and the first conductive wire 131, the second conductive wire 132, and the third conductive wires 133 all extend along the width direction of the backlight module 1. The first conductive wire 131 is electrically connected to the first pin 1111 of the light source 112 located at an end of the backlight module 1, the second conductive wire 132 is electrically connected to the second pin 1112 of the light source 112 located at another end of the backlight module 1, and the third conductive wire 133 is arranged between two adjacent light sources 112. An end of the third conductive wire 133 is connected to the first pin 1111 of the light source 112, and another end of the third conductive wire 133 is connected to the second pin 1112 of another light source 112.

It should be noted that one of the first pin 1111 and the second pin 1112 serves as the positive pin, and the other one of the first pin 1111 and the second pin 1112 serves as the negative pin. In practical applications, the pins of the light source 112 can be configured according to specific design and circuit requirements. Additionally, in the embodiments, that the mounting groove 1231 includes nine mounting sub-grooves 12312 arranged at intervals along the width direction of the backlight module 1, the light source assembly 11 includes nine light sources 112 (a first light source, a second light source . . . and a ninth light source) arranged at intervals along the width direction of the backlight module 1, and the driving circuit 13 includes the first conductive wire 131, the second conductive wire 132, and eight third conductive wires 133 is taken as an example. In practical applications, the number of the mounting sub-grooves 12312 and the number of the light sources 112 can be adjusted based on design requirements.

It can be understood that the embodiments optimize the arrangement of the plurality of light sources 112 by arranging the plurality of mounting sub-grooves 12312 at intervals, so that there is a more efficient light coupling relationship between the light source assembly 11 and the light guide plate 12, improving the light utilization rate, and enhancing the light emission efficiency of the backlight module 1. At the same time, the mounting groove 1231 is configured to adapt to the light source assembly 11 that may have different sizes, and can be configured for the design of various types of ultra-thin backlight modules 1, further improving product adaptability.

Specifically, the light source assembly 11 may include the plurality of light sources 112, a plurality of light source brackets, and fluorescent glue. Each of the light sources 112 corresponds to one of the light source brackets, and the light source brackets are configured to support and fix the light sources 112. The light source bracket includes a plurality of bracket inner walls, and the plurality of bracket inner walls surround an accommodating cavity. The light source 112 is arranged in the accommodating cavity, the fluorescent glue is arranged in the accommodating cavity, and the fluorescent glue covers the light source 112. The fluorescent glue is configured to encapsulate the light source 112, and at the same time improves the light-emitting uniformity of the light source 112. After the light emitted by the light source 112 is converted and diffused by the fluorescent glue, a softer and more uniform light emission effect is realized. The light source 112 includes, but is not limited to, a light-emitting diode (LED). The structure of the light source assembly 11 and the type of the light source 112 are not specifically limited in the embodiments.

Furthermore, the first conductive wire 131 is electrically connected to the first pin 1111 of the first light source 112, one of the third conductive wires 133 connects the second pin 1112 of the first light source 112 and the first pin 1111 of the second light source 112, one of the third conductive wires 133 connects the second pin 1112 of the second light source 112 and the first pin 1111 of the third light source 112, one of the third conductive wires 133 connects the second pin 1112 of the third light source 112 and the first pin 1111 of the fourth light source 112, one of the third conductive wires 133 connects the second pin 1112 of the fourth light source 112 and the first pin 1111 of the fifth light source 112, one of the third conductive wires 133 connects the second pin 1112 of the fifth light source 112 and the first pin 1111 of the sixth light source 112, one of the third conductive wires 133 connects the second pin 1112 of the sixth light source 112 and the first pin 1111 of the seventh light source 112, one of the third conductive wires 133 connects the second pin 1112 of the seventh light source 112 and the first pin 1111 of the eighth light source 112, one of the third conductive wires 133 connects the second pin 1112 of the eighth light source 112 and the first pin 1111 of the ninth light source 112, and the second conductive wire 132 is electrically connected to the second pin 1112 of the ninth light source 112, so that a series circuit structure is formed, thereby allowing the plurality of light sources 112 to be sequentially turned on, achieving stable current transmission and uniform light source driving.

Specifically, the backlight module 1 further includes a connecting member 19. The connecting member 19 includes, but not limited to, a flexible circuit board. An end of the connecting member 19 is arranged on the light-emitting surface 121 of the light guide plate 12 and is electrically connected to the driving circuit 13, another end of the connecting member 19 is bent along a lateral side of the light guide plate 12 to a side of the reflective layer 15 away from the light guide plate 12, and the another end of the connecting member 19 is connected to an external driving circuit or control circuit to realize power supply and control of the backlight module 1. For example, the connecting member 19 may be connected to a control circuit to receive a dimming signal, a power signal, or other control signal to drive the light source assembly 11 to operate normally.

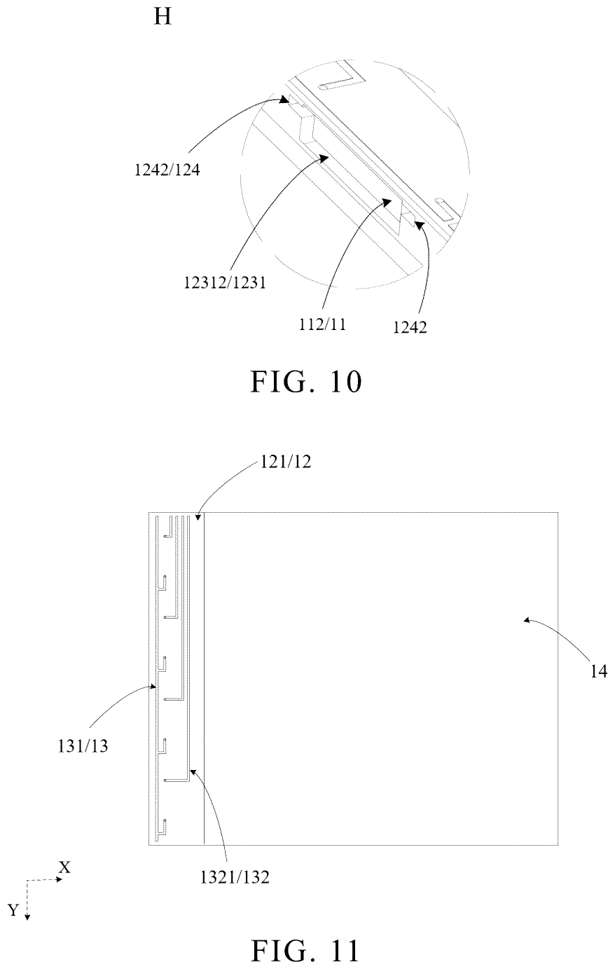

Please refer to FIG. 9, FIG. 10, and FIG. 11, in some embodiments, the driving circuit 13 includes a first conductive wire 131 and a second conductive wire 132. One of the first conductive wire 131 and the second conductive wire 132 is electrically connected to the first pins 1111, and the other of the first conductive wire 131 and the second conductive wire 132 is electrically connected to the second pins 1112, thereby realizing independent driving of each of the light sources 112 and improving reliability of the light source assembly 11.

Specifically, the first conductive wire 131 extends along the width direction of the backlight module 1, and the first conductive wire 131 is electrically connected to the first pin 1111 of each of the plurality of light sources 112, thereby realizing synchronous power supply and stable lighting. The second conductive wire 132 includes a plurality of first conductive sub-wires 1321 arranged at intervals along the length direction of the backlight module 1, and the first conductive sub-wires 1321 extend along the width direction of the backlight module 1. Each of the first conductive sub-wires 1321 is electrically connected with the second pin 1112 of a corresponding one of the light sources 112. In this way, the first pin 1111 of each of the light sources 112 shares a continuous first conductive wire 131, and the second pin 1112 of each of the light sources 112 is connected with the independent first conductive sub-wire 1321, respectively, thereby making the electrical connection structure of the light sources 112 clearer and easy to route.

Specifically, along the width direction of the backlight module 1, lengths of the plurality of first conductive sub-wires 1321 are different, thereby adapting to the needs of different positions and circuit layouts of the light sources 112, electrically connecting each of the first conductive sub-wires 1321 to the second pin 1112 of the corresponding one of the light sources 112, optimizing the current path, reducing signal loss or interference in the circuit, and thereby improving the working stability and efficiency of the backlight module 1.

Please continue to refer to FIG. 1, FIG. 2, and FIG. 12, the embodiments also provide a display device 2. The display device 2 includes a display panel 21 and the backlight module 1 described in any of the above embodiments. The backlight module 1 includes the light guide plate 12 and the optical film layer 14 disposed in a stacked manner, and the optical film layer 14 is disposed between the light guide plate 12 and the display panel 21.

The display panel 21 includes, but is not limited to, a liquid crystal display panel. A side of the optical film layer 14 is in contact with the light guide plate 12, and another side of the optical film layer 14 is in contact with the display panel 21. The light guide plate 12 is a glass light guide plate 12, thereby utilizing the physical characteristics of high rigidity of the glass to replace the frame adhesive, allowing the light guide plate 12, the optical film layer 14, and the display panel 21 to be directly attached. The light guide plate 12 serves as the carrier of the backlight module 1, thereby saving the material consumption, reducing the costs of the display device 2, and meeting the demand of thinning the display device 2.

Furthermore, the display device 2 may further include a housing 22. The display panel 21 and the backlight module 1 are located in the housing 22, and the housing 22 provides support, fixation, and protection for the display panel 21 and the backlight module 1.

It can be understood that the backlight module 1 has been described in detail in the above-described embodiments, which will not be repeated here.

Furthermore, the backlight module 1 further includes a light-shielding adhesive 18. The light-shielding adhesive 18 is arranged between the light guide plate 12 and the display panel 21, and the light guide plate 12 and the display panel 21 can be attached and fixed by the light-shielding adhesive 18. The light-shielding adhesive 18 can resist light leakage at the connection between the light guide plate 12 and the display panel 21, thereby preventing light leakage on the lateral surface 123 of the light guide plate 12.

In specific applications, the display device 2 may be a device having a display function, such as a smartphone, a tablet, a mobile phone, a video phone, an electronic book reader, a desktop computer, a laptop, a netbook, a workstation, a server, a personal digital assistant, a portable media player, a MP3 player, a mobile medical machine, a camera, a game console, a digital camera, a vehicle navigator, an electronic billboard, an ATM, or a wearable device.

In the above-described embodiments, the description of each embodiment has its own emphasis, and the parts not detailed in one embodiment can be referred to the relevant descriptions of other embodiments.

The backlight module and the display device provided by the embodiments of the present disclosure are described in detail above, and the principles and implementations of the present disclosure have been described herein with specific examples, and the description of the above implementations is only for helping to understand the methods and core ideas of the present disclosure. Meanwhile, those skilled in the art may change the specific embodiments and the scope of application according to the ideas of the present disclosure, and in summary, the contents of the present specification should not be construed as limiting the present disclosure.

What is claimed is:

1. A backlight module, comprising:
a light guide plate comprising a light-emitting surface, a bottom surface opposite to the light-emitting surface, and a lateral surface connecting the light-emitting surface and the bottom surface, wherein a mounting groove is provided on the lateral surface;
a light source assembly arranged in the mounting groove; and
a driving circuit electrically connected to the light source assembly,
wherein the driving circuit is arranged on at least one of the light-emitting surface and the bottom surface, and the driving circuit is located adjacent to the light source assembly.

2. The backlight module according to claim 1, wherein the light guide plate is provided with a connecting groove, and the connecting groove is communicated with the mounting groove; and
pins of the light source assembly are connected in the connecting groove in a slidable manner, and the pins of the light source assembly are electrically connected to the driving circuit through the connecting groove.

3. The backlight module according to claim 2, wherein the connecting groove comprises:
a first sub-groove provided on the light-emitting surface, wherein the first sub-groove penetrates part of the light guide plate along a thickness direction of the backlight module; and
a second sub-groove provided on the lateral surface, wherein the second sub-groove penetrates part of the light guide plate along a length direction of the backlight module, and the second sub-groove is communicated with the mounting groove;
wherein the driving circuit covers an opening of the first sub-groove, the backlight module comprises a conductive member arranged in the first sub-groove, an end of the conductive member is electrically connected to the driving circuit, and another end of the conductive member is electrically connected to the pins of the light source assembly.

4. The backlight module according to claim 3, wherein the connecting groove further comprises a limiting groove, the limiting groove is provided on a side of the first sub-groove away from the driving circuit, and the limiting groove is communicated with the first sub-groove; and
the pins of the light source assembly are arranged in the limiting groove, and the pins of the light source assembly are snap-fitted with the limiting groove.

5. The backlight module according to claim 4, wherein the limiting groove is communicated with the second sub-groove, a distance between a bottom of the limiting groove and the light-emitting surface is greater than a distance between a side of the second sub-groove away from the light-emitting surface and the light-emitting surface, such that a stepped limiting structure is formed.

6. The backlight module according to claim 4, wherein the conductive member is arranged on a side of the pins of the light source assembly away from the limiting groove, and at least part of the conductive member is located in the limiting groove.

7. The backlight module according to claim 1, wherein the mounting groove comprises a plurality of mounting sub-grooves arranged at intervals along a width direction of the backlight module, the light source assembly comprises a plurality of light sources arranged at intervals along the width direction of the backlight module, each of the light sources is arranged in a corresponding one of the mounting sub-grooves, and each of the light sources comprises a first pin and a second pin; and
the driving circuit comprises a first conductive wire and a second conductive wire, one of the first conductive wire and the second conductive wire is electrically connected to the first pin, and another one of the first conductive wire and the second conductive wire is electrically connected to the second pin.

8. The backlight module according to claim 7, wherein the first conductive wire extends along the width direction of the backlight module, and the first conductive wire is electrically connected to the first pin of each of the plurality of light sources; and
the second conductive wire comprises a plurality of first conductive sub-wires arranged at intervals along a length direction of the backlight module, each of the first conductive sub-wires extends along the width direction of the backlight module, each of the first conductive sub-wires is electrically connected to the second pin of a corresponding one of the light sources.

9. The backlight module according to claim 8, wherein lengths of the plurality of first conductive sub-wires are different along the width direction of the backlight module.

10. The backlight module according to claim 1, wherein the mounting groove comprises a plurality of mounting sub-grooves arranged at intervals along a width direction of the backlight module, the light source assembly comprises a plurality of light sources arranged at intervals along the width direction of the backlight module, each of the light sources is arranged in a corresponding one of the mounting sub-grooves, and each of the light sources comprises a first pin and a second pin; and
the driving circuit comprises a first conductive wire, a second conductive wire, and a plurality of third conductive wires, the first conductive wire is electrically connected to the first pin of one of the light sources located at an end of the backlight module, and the second conductive wire is electrically connected to the second pin of another one of the light sources located at another end of the backlight module, each of the third conductive wires is arranged between two adjacent ones of the light sources, one end of each of the third conductive wires is connected to the first pin of one of the light sources and another end of each of the third conductive wires is connected to the second pin of another one of the light sources.

11. The backlight module according to claim 1, wherein the backlight module further comprises a reflective layer, the reflective layer is disposed on the bottom surface of the light guide plate, and the reflective layer is in direct contact with a housing.

12. The backlight module according to claim 1, wherein a plurality of wire slots are provided on the light-emitting surface of the light guide plate, and the driving circuit is embedded in the wire slots.

13. The backlight module according to claim 1, further comprising an optical film layer, wherein the optical film layer is arranged on the light-emitting surface of the light guide plate and is spaced apart from the driving circuit.

14. The backlight module according to claim 1, wherein the light guide plate comprises a light-receiving surface located on a side of the mounting groove away from the light source assembly, and a distance between the light-receiving surface and the light source assembly is greater than or equal to zero.

15. The backlight module according to claim 14, wherein a cross section of the light-receiving surface is arc-shaped and convex in a direction away from the light source assembly.

16. The backlight module according to claim 1, further comprising a plurality of dots arranged inside the light guide plate, wherein the plurality of dots are arranged on at least one of a side of the bottom surface adjacent to the light-emitting surface and a side of the light-receiving surface away from the light source assembly.

17. The backlight module according to claim 1, further comprising a connecting member, wherein an end of the connecting member is arranged on the light-emitting surface of the light guide plate and is electrically connected to the driving circuit, and another end of the connecting member is bent along a lateral side of the light guide plate to a side of the bottom surface away from the light-emitting surface and is connected to an external driving circuit or control circuit.

18. A display device, comprising a display panel and a backlight module, the backlight module comprising:
a light guide plate comprising a light-emitting surface, a bottom surface opposite to the light-emitting surface, and a lateral surface connecting the light-emitting surface and the bottom surface, wherein a mounting groove is provided on the lateral surface;
a light source assembly arranged in the mounting groove; and
a driving circuit electrically connected to the light source assembly,
wherein the driving circuit is arranged on at least one of the light-emitting surface and the bottom surface, and the driving circuit is located adjacent to the light source assembly; and
the backlight module comprises the light guide plate and an optical film layer arranged in a stacked manner, the optical film layer is arranged between the light guide plate and the display panel, a side of the optical film layer is attached to the light guide plate, and another side of the optical film layer is attached to the display panel.

19. The display device according to claim 18, wherein the optical film layer is arranged on the light-emitting surface of the light guide plate and is spaced apart from the driving circuit.

20. The display device according to claim 18, wherein the backlight module further comprises a light-shielding adhesive arranged between the light guide plate and the display panel, and the light guide plate and the display panel are attached and fixed by the light-shielding adhesive.
